(19) United States
(12) Patent Application Publication
(10) Pub. No.: US 2007/0096974 A1
(43) Pub. Date: May 3, 2007

(54) Blending of sensors to produce alternate sensor characteristics

(75) Inventors: Jeffrey D. Gleacher, Merritt Island, FL (US); Emmanuel Garcia, South Lyon, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/580,708

(22) Filed: Oct. 13, 2006

Related U.S. Application Data
(60) Provisional application No. 60/728,003, filed on Oct. 14, 2005.

(51) Int. Cl. G01S 13/93

(52) U.S. Cl. 342/70; 342/71; 342/72; 342/106; 342/114; 342/118

(57) ABSTRACT

A method and system generates data within a middle range without a mid-range sensor by combining data within a high and low range. The example system uses high range satellite sensors and a low range sensor disposed within an ECU to obtain a first set of data in the high range and a second set of data in the low range. The first set of data and the second set of data are utilized to produce a third set of data within the middle range thereby eliminating the need for a mid-range sensor.

### CROSS REFERENCE TO RELATED APPLICATION

The application claims priority to U.S. Provisional Application No. 60/728,003 which was filed on Oct. 14, 2005.

### BACKGROUND OF THE INVENTION

This invention generally relates to a method of sensing data in different ranges. More particularly, this invention relates to a method of obtaining sensor data within a desired range with fewer sensors.

Sensors are utilized in many applications for obtaining data indicative of vehicle performance and conditions. A sensor includes a range and resolution in which data can be gathered. A wider range will usually require a sacrifice in resolution. Greater resolution can also limit the range at which a sensor can accurately collect data. Specific applications and data gathering applications require different ranges and resolution. Such different applications and data requirements often require the use of multiple sensors of different resolutions and ranges.

Occupant protection systems rely on sensors to detect when actuation of safety devices should be activated. Typically a vehicle will include a high range sensor disposed at outer points of the vehicle in order to detect a major impact condition. A mid-range sensor is typically required to detect front or side impacts. Mid-range sensors are in some instances located within a controller of the occupant protection system. Still another sensor with a low range is required for stability control and sensing.

Disadvantageously, each sensor requires supporting hardware and programming. Further, the different sensors all contribute to the overall cost of the vehicle.

Accordingly, it is desirable to design and develop a method and system that provides the same data required to detect vehicle performance and conditions with fewer sensors.

### SUMMARY OF THE INVENTION

A method and system generates data within a range without a sensor specifically allotted for that range by combining data within other ranges gathered by sensors of different ranges and resolutions.

Multiple sensors are utilized in different ways to detect different conditions. Algorithms for detecting front and side crash events require a mid-range acceleration sensor. The range of data gathered and utilized by an electronic control unit (ECU) from a mid-range sensor is around 50 g. The same algorithms also utilize data provided by satellite sensors disposed at the outer perimeter of the motor vehicle. The ECU also includes a low-range acceleration sensor that is utilized to provide data for traction or stability control functions and systems of the vehicle. Although each system utilizes acceleration data, that data is required within different ranges and resolutions and therefore require data within a specific range and resolution. For example, data from high range, mid-range and low-range sensors are required.

The example system uses high range satellite sensors, and the low range sensor to obtain a first set of data in the high range and a second set of data in the low range. The first set of data and the second set of data are utilized to produce a third set of data within the middle range without a mid-range sensor. The mid-range acceleration data is obtained by combining high-range data from the high-range satellite sensors, and low-range data from the low-range sensor disposed within the ECU.

Accordingly, the disclosed example method steps and system provides a method of producing data within a desired range using data gathered by sensors not optimal for the desired range. Further, the method produces desired data in a desired range without requiring additional sensors and the corresponding support hardware and programming that necessarily accompany additional sensors.

These and other features of the present invention can be best understood from the following specification and drawings, the following of which is a brief description.

### BRIEF DESCRIPTION OF THE DRAWINGS

FIG. 1 is a schematic illustration of an example system for detecting vehicle acceleration.

FIG. 2 is a graph illustrating example data ranges produced according to a disclosed example method.

FIG. 3 is a flow diagram illustrating example method steps for producing sensor data.

### DETAILED DESCRIPTION OF THE PREFERRED EMBODIMENT

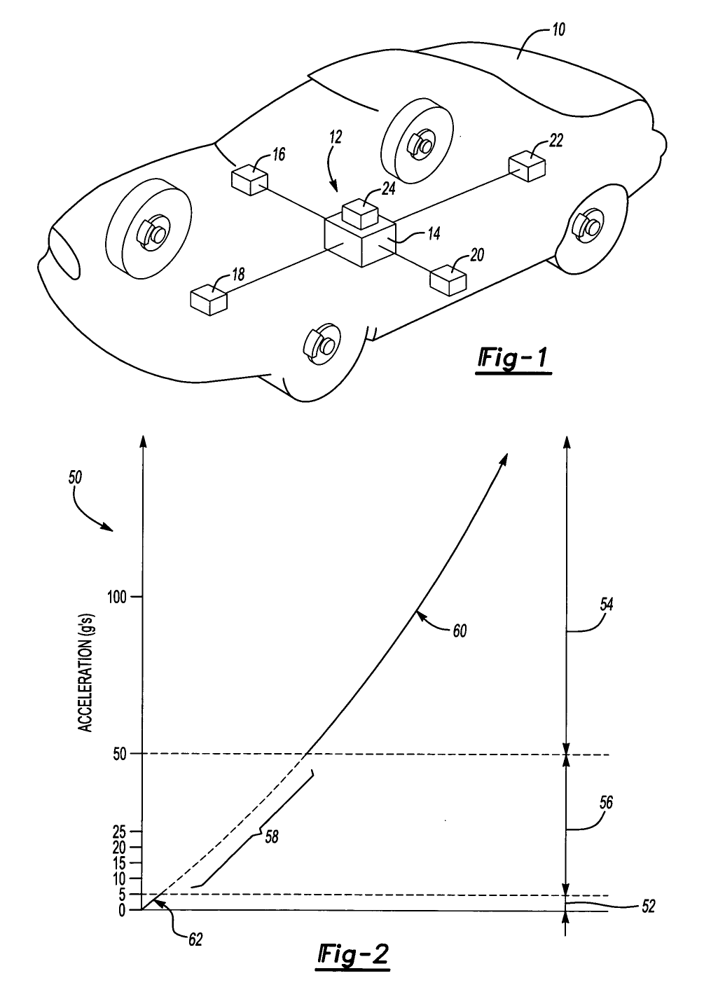

Referring to FIG. 1, a vehicle 10 is schematically shown and includes a collision detection system 12. The collision detection system 12 includes an electronic control unit (ECU) 14 for controlling specific vehicle functions. Multiple sensors are utilized in different ways to detect different conditions. Algorithms for detecting front and side crash events require a mid-range acceleration sensor. The range of data gathered and utilized by the ECU 14 from a mid-range sensor is around 50 g. The same algorithms also utilize data provided by satellite sensors 16,18,20,22 disposed at the outer perimeter of the motor vehicle 10.

The ECU 14 also includes a low-range acceleration sensor 24 that is utilized for other systems within the vehicle, such as traction or stability control systems, for example. Each of the example sensor, although all measuring acceleration, supply data within a specific desired range and resolution to provide for the specific system functions. Accordingly, data from high range, mid-range and low-range sensors are required.

Referring to FIG. 2, a graph 50, illustrates an example of acceleration data gathered by the various sensors within the vehicle 10. A low range of data 52 provides acceleration data up to about 5 g. This low range 52 provides high resolution compared to satellite sensors that must be capable of sensing data in the high range 54. A middle range 56 is utilized in concert with the data within the high range 54 to determine how the system 12 is activated.

The example system 12 uses high range satellite sensors 16, 18, 20, and 22 and the low range sensor 24 to obtain a first set of data 60 in the high range 54 and a second set of data 62 in the low range. The first set of data 60 and the second set of data 62 are utilized to produce a third set of data 58 within the middle range 56.

The example system eliminates the need for a mid-range sensor by generating the mid-range acceleration data by combining high-range data from high-range satellite sensors, and low-range data from the low-range sensor 24 disposed within the ECU 14.

The satellite sensors 16, 18, 20, and 22 provide a high-range of acceleration detection, at a low resolution as compared to the resolution provided by the low-range sensor 24 disposed within the ECU 14. The low-range sensor 24 provides a relatively low-range of acceleration detection, for example about 5 g. The system 12 does not include a mid-range sensor. Acceleration data gathered from the low-range sensor 24 and the high-range satellite sensors 16,18,20,22 are combined to provide the mid-range data desired for operation of the system 12.

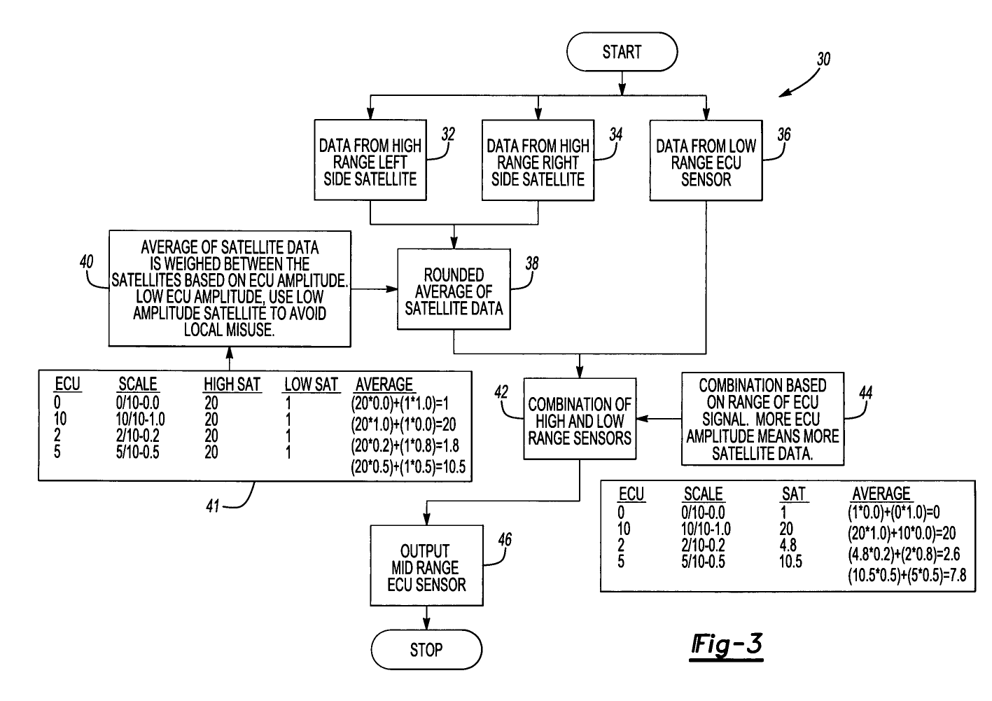

Referring to FIG. 3, a schematic diagram illustrates example method steps to obtain mid-range acceleration data without a mid-range acceleration sensor and begins by first obtaining data from both the satellite sensors 16, 18, 20, and 22 and the low range sensor 24 as indicated at 32, 34 and 36. The data from the satellite sensors 16, 18, 20 and 22 is verified by a bounded average 38 to compensate for possible affects of local abuse.

Satellite sensors are necessarily disposed at the outer perimeter of the vehicle and therefore are susceptible to local conditions that can register as a very high local acceleration. For example, a shopping cart collision or door slam can cause a local disturbance that would register as an extreme acceleration, but only on one side of the vehicle 10. Accordingly, data from the satellite sensors is weighted based on data gathered indicative of amplitude by the low range sensor 24 in the ECU 14 as is indicated at 40.

An example weighting is shown at 41 and includes a proportioning factor that is applied responsive to the detected condition. In the illustrated example, a different proportioning factor is applied responsive to the acceleration data gathered by the low-range sensor in the ECU 14. In the illustrated example, a high satellite sensor reading is combined with a low satellite reading depending on the amplitude of the acceleration at the ECU 14. For example, data gathered from the left satellite sensor 20 is combined with data gathered from the right satellite sensor 16. If the reading at the ECU 14 is substantially zero, the high reading is essentially disregarded and the low sensor reading is utilized. In a condition were the acceleration at the ECU 14 is at an upper end or maxed out in the lower range, the high satellite reading is weighted more.

Acceleration at the ECU 14 that is neither zero or maxed out, but is instead somewhere in the middle is weighted as a proportion of each of the high satellite reading and the low satellite reading. In the illustrated example there are two ranges illustrated that weight the high satellite reading with the low satellite reading according to a desired proportioning. Additional ranges can be utilized to further tailor the satellite acceleration data utilized in producing the desired mid-range sensor data.

Once the bounded average is obtained as indicated at 38 it is combined with low range sensor data as is indicated at 42. In this step, the low range acceleration data is combined, not just utilized to determine a weighted value of high and low sensors as was performed in steps 40 and 41.

Acceleration data from the low range acceleration sensor is combined with the data gathered from the high range acceleration sensor according to a weighting assigned to each data set depending on a magnitude of acceleration detected at the ECU 14. The greater the acceleration values as the ECU 14, the greater the weighting of the high range satellite acceleration sensors. The different ranges are applied incrementally to the data set to blend a first set of data produced as the bounded average of the satellite acceleration sensors, and a second data set produced by the low-range acceleration sensor 24 disposed within the ECU 14.

The first range is selected when there is no acceleration or signal detected at the ECU 14. In this instance, no weight is accorded the satellite sensor with the highest reading. A second range is selected and utilized when an acceleration value or signal is greater than the capability of the sensor within the ECU 14, such that the acceleration value has maxed out the low-range sensor capacity. In this instance, the second range provides for a greater weighting on data obtained from the high range acceleration sensor, and no weight accorded the data from the low-range sensor 24.

A third range is applied when data at the ECU 14 falls somewhere between the zero and the upper limit. In the third range, data from the high-range sensor is accorded a 20% weighting with the remaining 80% being applied and made up of data from the low-range acceleration sensor. In a fourth range, data from the high-range sensor and the low range sensor are accorded equal weighting. It should be understood that the example ranges can be added to or modified to obtain desirable weightings of data obtained from the different sensors to produce mid-range sensor data as desired.

The weighted values from the low-range sensor and the high-range sensor are then combined to provide desired data in a mid-range. Mid-range data is therefore provided without an actual sensor and can be utilized just as would otherwise be utilized if obtained directly from an actual sensor.

The method has been described and illustrated by way of specific example to producing vehicle acceleration data within a mid-range. However, other systems may utilize this method to produce data without sensors utilizing data gathered from other sensors of bounded ranges. Accordingly, the disclosed example method steps provide a method of producing data within a desired range using data gathered by sensors not optimal for the desired ranges. Further, the method produces desired data in a desired range without requiring additional sensors and the corresponding support hardware and programming that necessarily accompany additional sensors.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of producing data within a desired range without a sensor for the desired range comprising the steps of:
a) verifying data from at least two high sensors having a first range with data obtained from a low sensor with a second range different than the first range;
b) comparing the verified data from the high sensors with data from the low sensor; and
c) producing data within a third range different than the first and second range with the compared data from the high sensors and the low sensor.

2. The method as recited in claim 1, wherein the third range comprises a range between the first range and the second range.

3. The method as recited in claim 2, wherein the third range comprises data generated to duplicate output of a sensor.

4. The method as recited in claim 1, wherein data from the two high sensors is weighted according to data gathered from the low sensor.

5. The method as recited in claim 1, wherein data from one of the two high sensors is disregarded responsive to the low sensor obtaining a reading below a desired level.

6. The method as recited in claim 1, wherein data from the two high sensors is combined proportionally responsive to a data value obtained by the low sensor.

7. The method as recited in claim 1, wherein data from the two high sensors and the low sensor are combined proportionally responsive to a data value obtained by the low sensor.

8. A method of obtaining vehicle crash data within a desired range without a sensor corresponding to the desired range comprising the steps of:
a) obtaining a first data set from at least two high-range sensors for obtaining data in a range greater than the desired range;
b) obtaining a second data set from a low-range sensor for obtaining data in a range less than the desired range, wherein the low-range sensor is disposed within an electronic control unit of the vehicle; and
c) combining the first data set and the second data set to produce a third data set within a mid-range that is different than the first data set and the second data set.

9. The method as recited in claim 8, wherein the at least two high range sensors comprise sensors for measuring data indicative of vehicle acceleration in a range greater than 50 g.

10. The method as recited in claim 8, wherein the low range sensor comprises a sensor for measuring data indicative of vehicle acceleration in a range less than 10 g.

11. The method as recited in claim 8, wherein the third data set includes data within a range between 10 g and 50 g.

12. The method as recited in claim 8, including the steps of verifying data of the high range sensors by comparing data from each of the high range sensors with data obtained from the low range sensor.

13. The method as recited in claim 8, including the step of combining verified data from the high range sensors with the low range sensor according to the second data set to produce the third data set within the mid-range.

14. A vehicle collision detection system comprising:
a first satellite sensor and a second satellite sensor disposed near an edge of a vehicle, wherein the first satellite sensor and the second satellite sensor obtain data indicative of vehicle acceleration in a first range;
an electronic control unit disposed within the vehicle for controlling a vehicle system;
a low-range sensor disposed within the electronic control unit for obtaining data indicative of vehicle acceleration in a second range lower than the first range, wherein data gathered from the first satellite sensor and the second satellite sensor are combined with data gathered from the low range sensor to produce data within a third range, where the third range is greater than the second range and less then the first range.

15. The system as recited in claim 14, wherein the first and second satellite sensors gather data at a first resolution, and the low-range sensor gathers data at a second resolution that is greater than the first resolution.

16. The system as recited in claim 15, wherein data produced in the third range comprises a third resolution that is greater than the first resolution and less than the second resolution.

17. The system as recited in claim 16, wherein data within the third range is utilized to verify data gathered by the first satellite sensor and the second satellite sensor.

18. The system as recited in claim 17, wherein the third set of data within the third range is produced by combining verified data from the first and second satellite sensors with data from the low-range sensor.
